(19) United States
(12) Patent Application Publication
(10) Pub. No.: US 2015/0160821 A1
(43) Pub. Date: Jun. 11, 2015

(54) METHOD OF ARRANGING MEDICAL IMAGES AND MEDICAL APPARATUS USING THE SAME

(71) Applicant: SAMSUNG ELECTRONICS CO., LTD., Suwon-si (KR)

(72) Inventors: Hyug-rae CHO, Seoul (KR); Hei-soog KIM, Gunpo-si (KR); Seon-mi PARK, Seoul (KR); Je-yong SHIN, Suwon-si (KR)

(73) Assignee: SAMSUNG ELECTRONICS CO., LTD., Suwon-si (KR)

(21) Appl. No.: 14/503,521

(22) Filed: Oct. 1, 2014

(30) Foreign Application Priority Data
Dec. 9, 2013 (KR) 10-2013-0152648

(51) Int. Cl. G06F 3/0486; G06F 3/0484

(52) U.S. Cl. CPC G06F 3/0486; G06F 3/04842

(57) ABSTRACT

Disclosed are a method for arranging medical image sets and a medical apparatus configured to implement the method. The method includes displaying a plurality of medical image sets, receiving a selection of a first medical image set from among the plurality of medical image sets, receiving a user input that facilitates a movement of the selected first medical image set to a region in which a second medical image set is displayed, and changing an arrangement of the plurality of medical image sets based on the user input.

### CROSS-REFERENCE TO RELATED APPLICATION

This application claims priority from Korean Patent Application No. 10-2013-0152648, filed on Dec. 9, 2013, in the Korean Intellectual Property Office, the disclosure of which is incorporated herein by reference in its entirety.

### BACKGROUND

1. Field

One or more exemplary embodiments relates to a method of arranging a plurality of medical image sets and a medical apparatus using the same.

2. Description of the Related Art

Magnetic resonance imaging (MRI) apparatuses expose an atomic nucleus to a magnetic field, and display an image by using information which is obtained via resonance. The resonance of an atomic nucleus denotes a phenomenon in which a specific high frequency is input to an atomic nucleus magnetized by an external magnetic field, and thus, an atomic nucleus having a low energy level absorbs high frequency energy to thereby be excited to a high energy level. Different atomic nuclei have different resonance frequencies, and resonance is affected by an intensity of an external magnetic field. There are numerous atomic nuclei in the human body, and a hydrogen atomic nucleus is used to capture a magnetic resonance image.

The MRI apparatuses are non-invasive, exhibit a better contrast of tissue than computed tomography (CT) apparatuses, and have no artifacts caused by osseous tissue. In addition, the MRI apparatuses may capture images of various cross-sectional surfaces in a desired direction even without changing a position of an object, and thus are widely used along with other image diagnostic apparatuses.

### SUMMARY

One or more exemplary embodiments include a medical image arranging method for freely changing positions of a plurality of medical image sets, which have previously been loaded based on a user input, and a medical apparatus using the same.

Additional aspects will be set forth in part in the description which follows and, in part, will be apparent from the description, or may be learned by practice of the exemplary embodiments.

According to one or more exemplary embodiments, a method for arranging a plurality of medical images includes: displaying a plurality of medical image sets; receiving a selection of a first medical image set from among the plurality of medical image sets; receiving a user input that facilitates a movement of the selected first medical image set to a region in which a second medical image set is displayed; and changing arrangement of the plurality of medical image sets, based on the received user input.

The first medical image set may include a plurality of cross-sectional images of an object.

The first medical image set may include a first plurality of medical images that are acquired by using a first protocol, and the second medical image set may include a second plurality of medical images that are acquired by using a second protocol that is different from the first protocol.

The displaying the plurality of medical image sets may include: for each of the plurality of medical image sets, selecting at least one representative image; and displaying a list of the selected representative images.

The displaying the plurality of medical image sets may include displaying, for each of the plurality of medical image sets, information which relates to a respective number of medical images included in the corresponding one of the plurality of medical image sets.

The receiving the selection may include: receiving a drag input by which the first medical image set is touched for at least a predetermined time interval; and switching an operational mode of the first medical image set to a moving mode such that the first medical image set is moved based on the drag input.

The switching of an operational mode may include changing a color associated with the first medical image set to a color which corresponds to the moving mode.

The switching the operational mode may include providing an indicator which indicates the moving mode on the first medical image set.

The receiving the user input may include receiving a drag input by which the first medical image set is dragged into the region in which the second medical image set is displayed, while the first medical image set is being touched.

The changing the arrangement may include: causing the first medical image set to be moved into a first region in which the second medical image set is displayed; and causing the second medical image set to be moved into a region which is different from the first region.

The changing the arrangement may include moving the first medical image set into a first region in which the second medical image set is displayed, and moving the second medical image set into a second region in which the first medical image set was displayed prior to being moved into the first region.

According to one or more exemplary embodiments, a medical apparatus includes: a display device configured to display a plurality of medical image sets; a user input device configured to receive a selection of a first medical image set from among the plurality of medical image sets, and to receive a user input that facilitates a movement of the selected first medical image set to a region in which a second medical image set is displayed; and a controller configured to change an arrangement of the plurality of medical image sets, based on the received user input.

The first medical image set may include a plurality of cross-sectional images of an object.

The first medical image set may include a first plurality of medical images that are acquired by using a first protocol, and the second medical image set may include a second plurality of medical images that are acquired by using a second protocol that is different from the first protocol.

The controller may be further configured to select, for each of the plurality of medical images sets, at least one representative image, and to control the display device to display a list of the selected representative images.

The display device may be further configured to display, for each of the plurality of medical image sets, information which relates to a respective number of medical images included in the corresponding one of the plurality of medical image sets.

The user input device may be further configured to receive a drag input by which the first medical image set is touched for at least a predetermined time interval, and the controller may be further configured switch an operational mode of the first medical image set to a moving mode such that the first medical image set is moved based on the drag input.

The controller may be further configured to change a color associated with the first medical image set to a color which corresponds to the moving mode.

The display device may be further configured to display an indicator which indicates the moving mode on the first medical image set.

The user input device may be further configured to receive a drag input by which the first medical image set is dragged into the region in which the second medical image set is displayed, while the first medical image set is being touched.

The controller may be further configured to cause the first medical image set to be moved into a first region in which the second medical image set is displayed, and to cause the second medical image set to be moved into a region which is different from the first region.

The controller may be further configured to cause the first medical image set to be moved into a first region in which the second medical image set is displayed, and to cause the second medical image set to be moved into a second region in which the first medical image set was displayed prior to being moved into the first region.

According to one or more exemplary embodiments, a method for arranging a plurality of medical images includes: displaying a plurality of medical image sets; receiving a user input that indicates a positional change which relates to a first medical image set from among the plurality of medical image sets with respect to a display of the plurality of medical image sets; and rearranging the display of the plurality of medical image sets based on the received user input.

The first medical image set comprises a first plurality of medical images that are acquired by using a first protocol, and at least a second medical image set from among the plurality of medical image sets comprises a second plurality of medical images that are acquired by using a second protocol that is different from the first protocol.

The displaying the plurality of medical image sets may include: for each of the plurality of medical image sets, selecting at least one respective representative image; and displaying a list of the selected representative images.

The displaying the plurality of medical image sets may include displaying, for each of the plurality of medical image sets, information which relates to a respective number of medical images included in the corresponding one of the plurality of medical image sets.

The rearranging the display may include: shifting a display position of the first medical image set based on the received user input; and shifting a display position of at least a second medical image set from among the plurality of medical image sets based on the shifted display position of the first medical image set.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a diagram which illustrates a medical apparatus, according to an exemplary embodiment;

FIG. 2 illustrates diagrams which illustrate a general method for providing a plurality of medical image lists;

FIG. 3 is a flowchart which illustrates a medical image arranging method, according to an exemplary embodiment;

FIGS. 4A, 4B, 4C, and 4D are diagrams which illustrate an example in which an arrangement of a plurality of medical image sets is changed based a user input which facilitates a movement of a medical image set, displayed in a prior-order region, to a posterior-order region;

FIGS. 5A and 5B are diagrams which illustrate an example in which an arrangement of a plurality of medical image sets is changed based on a user input which facilitates a movement of a medical image set, displayed in a posterior-order region, to a prior-order region;

FIGS. 6A and 6B are diagrams which illustrate an example in which positions of a plurality of medical image sets are switched therebetween based on a user input;

FIGS. 7A, 7B, and 7C are diagrams which illustrate an example in which an arrangement of a plurality of medical image sets is changed based on an input which facilitates a movement of a medical image set to another page which is not displayed on a screen; and

FIGS. 8 and 9 are block diagrams which illustrate a medical apparatus, according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

Terms used in the present disclosure have been selected as general terms which are widely used at present, in consideration of the functions of the exemplary embodiments, but may be altered according to the intent of a user of an operation unit of ordinary skill in the art, conventional practice, or introduction of new technology. Further, if there is a term which is arbitrarily selected by the applicant in a specific case, a meaning of the term will be described in detail in a corresponding description portion of the present disclosure. Therefore, the terms should be defined on the basis of the entire content of this specification instead of a simple name of each of the terms.

In this disclosure below, when it is described that one comprises (or includes or has) some elements, it should be understood that it may comprise (or include or has) only those elements, or it may comprise (or include or have) other elements as well as those elements if there is no specific limitation. Moreover, terms such as “ . . . unit”, “ . . . apparatus” and “module” described in the specification denote an element for performing at least one function or operation, and may be implemented in hardware, software or the combination of hardware and software.

The term “image” used herein may denote multi-dimensional data composed of discrete image factors (for example, pixels in a two-dimensional (2D) image and/or pixels in a three-dimensional (3D) image).

The term “object” or “examinee” used herein may include a person, an animal, a part of the person, and/or a part of the animal. For example, an object may include an organ such as the liver, the heart, the womb, the brain, breasts, the abdomen, or the like, or a blood vessel. Further, the term “object” may include a phantom. The phantom denotes a material having a volume very close to a density of organisms and an effective atomic number, and may include a spherical phantom having characteristics similar to those of a human body.

The term “user” used herein refers to a medical expert, and may include a doctor, a nurse, a medical technologist, a medical image expert, and/or the like, or may include an engineer repairing a medical apparatus. However, the user is not limited thereto.

Hereinafter, exemplary embodiments will be described in detail to be easily implementable by those of ordinary skill in the art with reference to the accompanying drawings. The present inventive concept may, however, be embodied in many different forms and should not be construed as being limited to the exemplary embodiments set forth herein. In the accompanying drawings, a portion irrelevant to a description of the exemplary embodiments will be omitted for clarity. Like reference numerals refer to like elements throughout.

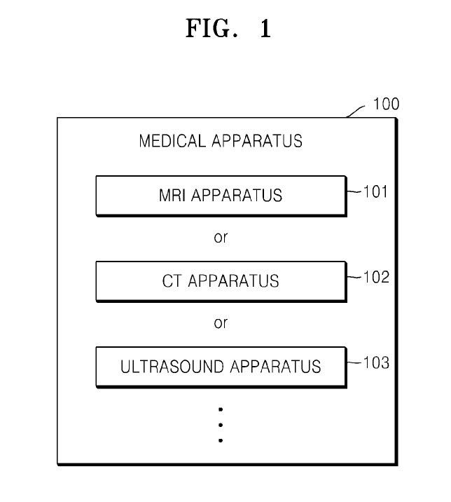

FIG. 1 is a diagram which illustrates a medical apparatus 100, according to an exemplary embodiment.

According to an exemplary embodiment, the medical apparatus 100 may include an apparatus that acquires a medical image, and displays the medical image on a screen. For example, the medical apparatus 100 may include any one or more of a magnetic resonance imaging (MRI) apparatus 101, a computed tomography (CT) apparatus 102, an X-ray photographing apparatus (not shown), an angiography apparatus (not shown), and/or an ultrasound apparatus 103, but is not limited thereto.

The MRI apparatus 101 is an apparatus that expresses an intensity of a magnetic resonance (MR) signal to an RF signal (which is generated in a magnetic field having a certain intensity) as a contrast, and thus obtains a tomographic image of a part of an object.

The CT apparatus 102 may provide a cross-sectional image of an object, thus expressing internal structures (for example, organs such as a kidney, lungs, etc.) of the object so as not to overlap therebetween, unlike general X-ray photographing apparatuses. The CT apparatus 102 may obtain a plurality of pieces of image data, each piece having a thickness that is not greater than 2 mm, at a speed of approximately several tens per second to several hundred times per second, and then may process the plurality of pieces of image data, so that the CT system may provide a relatively accurate cross-sectional image of the object.

The X-ray photographing apparatus denotes an apparatus that irradiates X-rays onto a human body in order to acquire an image of an internal structure of the human body. The angiography apparatus is an apparatus that enables a user to look at a blood vessel (i.e., an artery or a vein) of an object into which a contrast medium is injected via a thin tube, called a catheter, having a diameter of about 2 mm.

The ultrasound apparatus 103 denotes an apparatus that transfers an ultrasound signal from a surface of an object to a certain part of a human body, and obtains a tomographic image of soft tissue or an image of blood flow by using information which is obtained from an ultrasound signal reflected from internal tissue of the human body.

According to an exemplary embodiment, the medical apparatus 100 may be implemented in any one or more of various types. For example, the medical apparatus 100 described herein may be implemented as a mobile terminal and/or as a fixed-type terminal. Examples of the mobile terminal may include a smartphone, a laptop computer, a personal digital assistant (PDA), and a tablet personal computer (PC).

According to an exemplary embodiment, the medical apparatus 100 may exchange data with a hospital server or another medical device in a hospital that is connected with a picture archiving and communications system (PACS). Furthermore, the medical apparatus 100 may perform data communication in accordance with the digital imaging and communications in medicine (DICOM) standard.

According to an exemplary embodiment, the medical apparatus 100 may include a touch screen. The touch screen may be configured to detect a touch pressure in addition to a touch input position and a touched area. Further, the touch screen may be configured to detect a proximity touch, i.e., a touch based on close proximity to the screen in the absence of direct physical contact, as well as an actual touch, i.e., a touch based on direct physical contact with the screen.

Herein, the term “real touch” denotes a case in which a pointer directly and physically touches a screen, and the term “proximity touch” denotes a case in which the pointer does not actually touch the screen, but instead approaches a position which is separated from the screen to within a predetermined threshold distance.

According to an exemplary embodiment, the medical apparatus 100 may sense a user's touch gesture for an ultrasound image via the touch screen. Examples of a user's touch gesture described herein may include any one or more of a tap, a touch and hold, a double tap, a drag, panning, a flick, a drag and drop, a swipe, and a pinch.

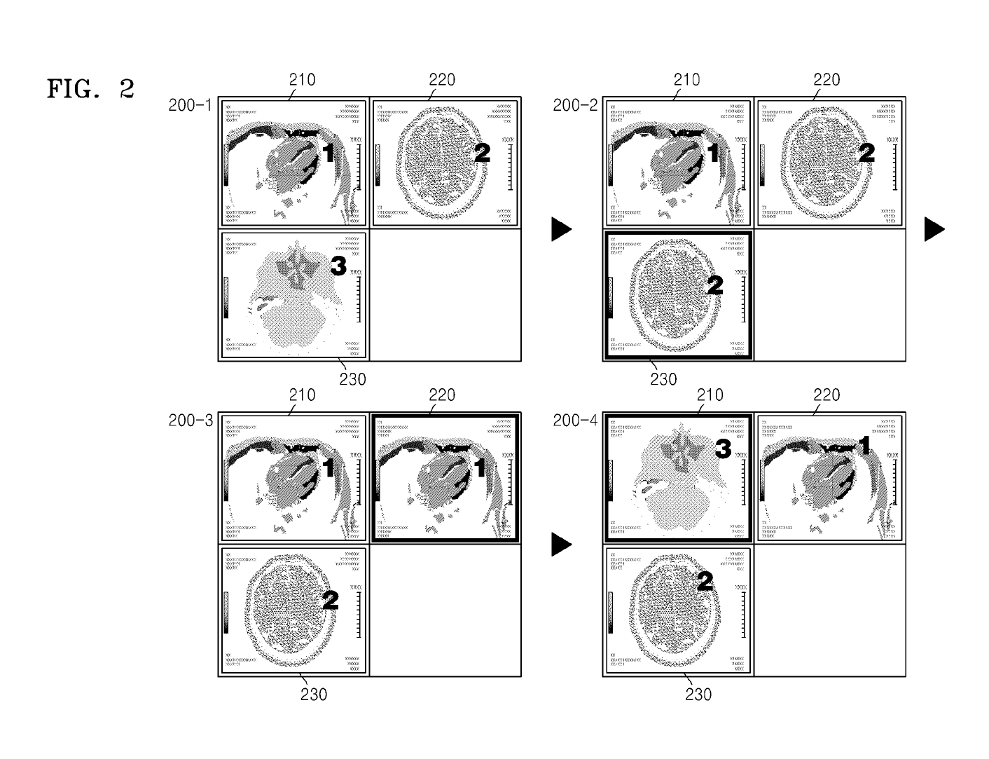

According to an exemplary embodiment, the medical apparatus 100 may load a plurality of images from a memory, and display the images in a certain region of a display device, such as, for example, a monitor which has a screen. This will be described in detail below with reference to FIG. 2.

FIG. 2 illustrates diagrams which illustrate a general method for providing a plurality of medical image lists.

As illustrated in drawing 200-1 of FIG. 2, the medical apparatus 100 may display a first image in a first region 210, display a second image in a second region 220, and display a third image in a third region 230.

As an example, the following description will be made with respect to a case in which a user desires to display the third image in the first region 210, display the first image in the second region 220, and display the second image in the third region 230. The user may change the arrangement of the images by performing several manipulations.

For example, as illustrated in drawing 200-2 of FIG. 2, the medical apparatus 100 may again load the second image on the third region 230 in order to display the loaded second image, based on a first user input. Then, as illustrated in drawing 200-3 of FIG. 2, the medical apparatus 100 may again load the first image on the second region 220 in order to display the loaded first image, based on a second user input. Subsequently, as illustrated in drawing 200-4 of FIG. 2, the medical apparatus 100 may again load the third image on the first region 210 in order to display the loaded third image, based on a third user input.

In this case, there is a difficulty in that the user changes the arrangement of the images by performing several manipulations, and the medical apparatus 100 again loads the images displayed on a screen.

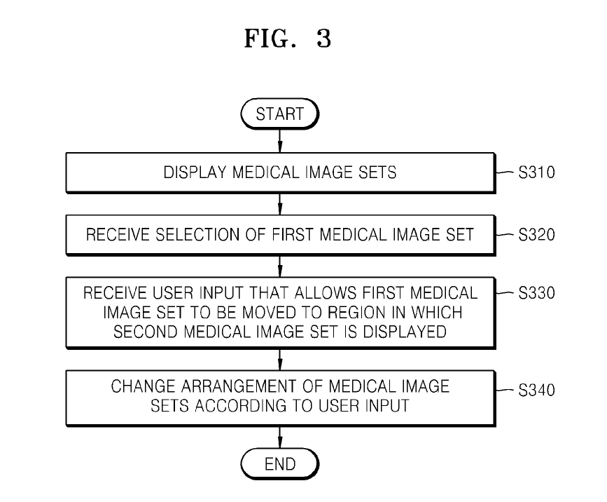

Therefore, a graphical user interface (GUI) that enables a user to freely change the arrangement of medical images via simple manipulation is needed. Hereinafter, a method by which the medical apparatus 100 freely changes the arrangement of a plurality of medical image sets based on a user input will be described in detail with reference to FIG. 3.

FIG. 3 is a flowchart which illustrates a medical image arranging method, according to an exemplary embodiment.

In operation S310, the medical apparatus 100 may display a plurality of medical image sets.

A medical image described herein may be implemented in any one or more of various ways. Examples of the medical image may include an MR image, a CT image, an ultrasound image, and/or an X-ray image, but are not limited thereto. The medical image may include at least one of a brightness (B) mode image in which a level of an ultrasound echo signal reflected from an object is expressed as brightness, a color Doppler image in which a speed of a moving object is expressed as a color by using the Doppler effect, a spectral Doppler image in which an image of a moving object is expressed as a spectrum type by using the Doppler effect, a motion (M) mode image that shows a motion of an object over time at a certain place, and an elasticity mode image in which a reaction difference between when a compression is applied to an object and when the compression is not applied to the object is expressed as an image, but is not limited thereto. Further, the medical image may include any one or more of a two-dimensional (2D) image, a three-dimensional (3D) image, and/or a four-dimensional (4D) image. Hereinafter, for convenience of description, a 2D image will be described as an example of an MR image.

According to an exemplary embodiment, the medical apparatus 100 may receive at least one medical image, selected by a user, from a memory in order to generate the plurality of medical image sets. Further, according to an exemplary embodiment, the medical apparatus 100 may receive medical images, selected by the user, from the outside in order to generate a plurality of medical image sets which include the received medical images.

Each of the medical image sets denotes a set of medical images which are classified based on the user's selection or a predetermined reference. Depending on the case, each medical image set may be expressed as a medical image stack or a medical image group.

According to an exemplary embodiment, each of first and second medical image sets may include a plurality of cross-sectional images of an object. For example, the first medical image set and/or the second medical image set may include a plurality of cross-sectional images of a brain.

According to an exemplary embodiment, each of the first and second medical image sets may include a plurality of medical images that are acquired by using a same protocol, or may include a plurality of medical images that are acquired by using different protocols.

A particular protocol may include at least one pulse sequence, and is a concept that is classified based on a part of an examinee of which images are being obtained. For example, examples of the protocol may include a head protocol for photographing a head, a neck protocol for photographing a neck, and a waist protocol for photographing a waist, etc., but are not limited thereto. To provide a detailed description of the head protocol as an example, the head protocol may include a pulse sequence for acquiring a scout image, a pulse sequence for acquiring an axial view image that includes a cross-sectional surface of an examinee in a width-axis direction, and a pulse sequence for acquiring a T1 emphasis image for anatomical observation. It may be easily understood by one of ordinary skill in the art that the head protocol may further include any one or more of various kinds of pulse sequences, in addition to the above-described pulse sequences.

For example, the first medical image set may include a plurality of medical images that are acquired by using a first protocol (for example, the head protocol), and the second medical image set may include a plurality of medical images that are acquired by using a second protocol (for example, the neck protocol) that is different from the first protocol (for example, the head protocol).

According to an exemplary embodiment, each of the first and second medical image sets may include medical images acquired from different respective medical apparatuses. For example, the first medical image set may include a plurality of MR images, and the second medical image set may include a plurality of CT images.

According to an exemplary embodiment, the first and second medical image sets may be displayed in different pages. For example, when there is a large number of medical image sets, the medical apparatus 100 may display the plurality of medical image sets in a plurality of pages.

According to an exemplary embodiment, for each of a plurality of medical image sets, the medical apparatus 100 may select a corresponding representative image. In this case, according to an exemplary embodiment, the medical apparatus 100 may automatically select a representative image, or may select the representative image based on a user input.

According to an exemplary embodiment, the medical apparatus 100 may display a list of representative images which respectively correspond to respective ones of a plurality of medical image sets, for displaying the plurality of medical image sets. According to another exemplary embodiment, the medical apparatus 100 may display a list of identification information (for example, a name of a medical image set) which corresponds to a plurality of medical image sets, for displaying the plurality of medical image sets.

Hereinafter, displaying a plurality of medical image sets may denote displaying a list of representative images and/or a list of identification information, which respectively correspond(s) to a plurality of medical image sets. Further, selecting a medical image set may denote selecting a representative image or identification information, which corresponds to a medical image set.

According to an exemplary embodiment, the medical apparatus 100 may display information which relates to a respective number of medical images which are included in corresponding ones of a plurality of medical image sets. For example, when the number of medical images included in the first medical image set is 24 and a representative image is a third image from among the 24 medical images, the medical apparatus 100 may display ‘3/24’. Further, the medical apparatus 100 may provide a search button (for example, ‘ [symbol] ’ and ‘ [symbol] ’) which may be used to search for medical images included in each of a plurality of medical image sets. The user may change a representative image by using the search button. For example, by using the search button, the user may change a representative image which is displayed at the uppermost portion of a medical image set.

In operation S320, the medical apparatus 100 may receive a selection of the first medical image set from among the plurality of medical image sets.

According to an exemplary embodiment, the medical apparatus 100 may receive a touch input that facilitates a touch contact with respect to the first medical image set for at least a predetermined time interval. For example, the medical apparatus 100 may receive a touch input that facilitates a touch contact with respect to the first medical image set for 7 seconds or more.

In particular, the predetermined time interval may be set by the user, or may be set by the medical apparatus 100 or a server. The predetermined time interval may be changed by the user or a system.

In the present disclosure, the touch input that facilitates a touch contact with respect to the first medical image set for a predetermined time interval may include at least one of a long click input, which touches the first medical image set with a cursor (or a pointer), and a touch-and-hold input that touches the first medical image set with a finger or an electronic pen, but is not limited thereto.

According to an exemplary embodiment, the medical apparatus 100 may switch an operation mode of the first medical image set to a moving mode, based on a touch input. In the moving mode, movement of the first medical image set may be activated. For example, in the moving mode, the first medical image set may be moved based on a drag input provided by the user.

According to an exemplary embodiment, the medical apparatus 100 may display a switching of the operation mode of the first medical image set to the moving mode. For example, the medical apparatus 100 may change a color associated with the first medical image set to a color (for example, blue) which corresponds to the moving mode. Further, the medical apparatus 100 may change a transparency of the first medical image set in the moving mode. For example, the medical apparatus 100 may set the transparency of the first medical image set to a transparency level of about 60% in the moving mode.

According to an exemplary embodiment, the medical apparatus 100 may provide an indicator which indicates the moving mode on the first medical image set. For example, the medical apparatus 100 may mark (i.e., display) an icon, a sign, and/or a text on the first medical image set, change a thickness, a shape, and/or a color of a border, and/or apply a flickering effect.

In operation S330, the medical apparatus 100 may receive a user input that facilitates a movement of the selected first medical image set to a region in which the second medical image set is displayed.

For example, the medical apparatus 100 may receive a drag input by which the first medical image set is dragged into the region, in which the second medical image set is displayed, while the first medical image set is being touched (or clicked). At this time, the drag input may be terminated in the region in which the second medical image set is displayed.

According to an exemplary embodiment, the first medical image set may not accurately be dropped in the region in which the second medical image set is displayed. In this case, the medical apparatus 100 may calculate a degree of overlap between the first medical image set and regions in which the plurality of medical image sets are respectively displayed, and based on the degree of overlap, the medical apparatus 100 may determine a position to which the first medical image set is to be moved. For example, when a degree of overlap between the dropped first medical image set and the region (in which the second medical image set is displayed) is about 90%, the medical apparatus 100 may determine an intention of the user as intending to cause the first medical image set to be moved to the region in which the second medical image set is displayed.

According to an exemplary embodiment, the region in which the first medical image set is displayed and the region in which the second medical image set is displayed may be included in different pages.

In operation S340, the medical apparatus 100 may change the arrangement of the plurality of medical image sets based on a user input that facilitates a movement of the first medical image set to the region in which the second medical image set is displayed.

According to an exemplary embodiment, the medical apparatus 100 may cause the first medical image set to be moved into a first region in which the second medical image set is displayed, and cause the second medical image set to be moved into a region previous or subsequent to (i.e., different than) the first region.

For example, when the moved first medical image set had previously been displayed in a higher-order region than that of the second medical image set, the medical apparatus 100 may move the second medical image set to a region prior to (i.e., of a higher order than) the first region. Conversely, when the moved first medical image set was displayed in a lower-order region than that of the second medical image set, the medical apparatus 100 may move the second medical image set to a region subsequent to (i.e., of a lower order than) the first region.

According to an exemplary embodiment, the medical apparatus 100 may move all or some of the other medical image sets except the first and second medical image sets from among the plurality of medical image sets.

According to an exemplary embodiment, the medical apparatus 100 may move the first medical image set to the first region in which the second medical image set is displayed, and move the second medical image set to a second region in which the first medical image set was displayed prior to being moved.

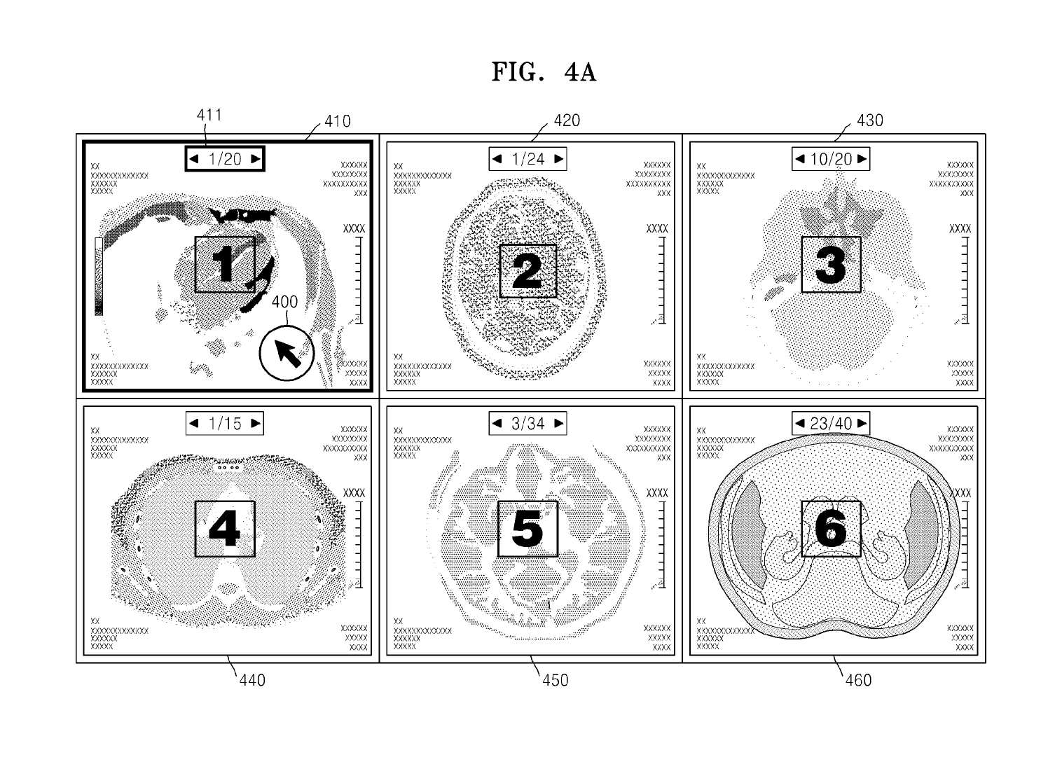

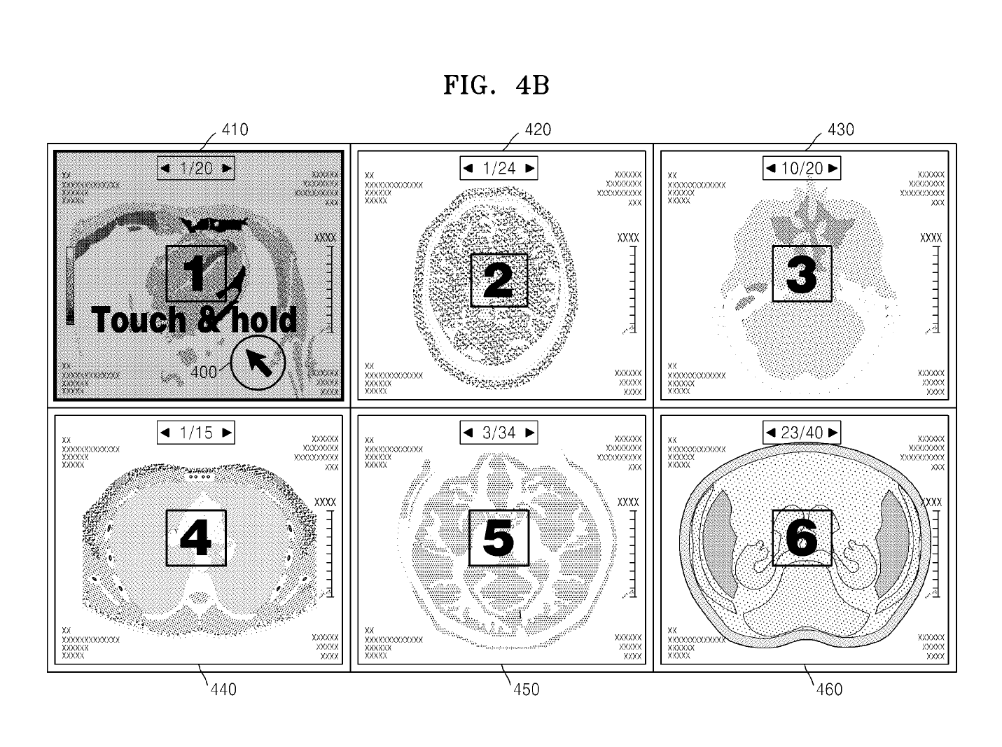

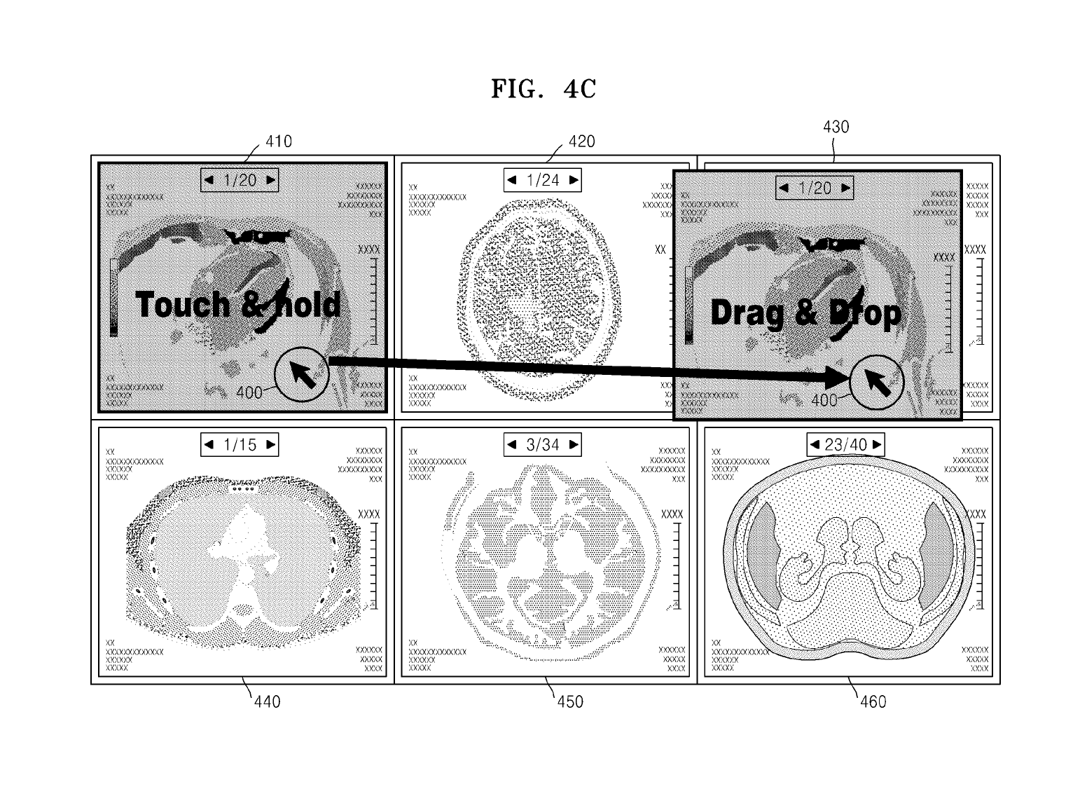

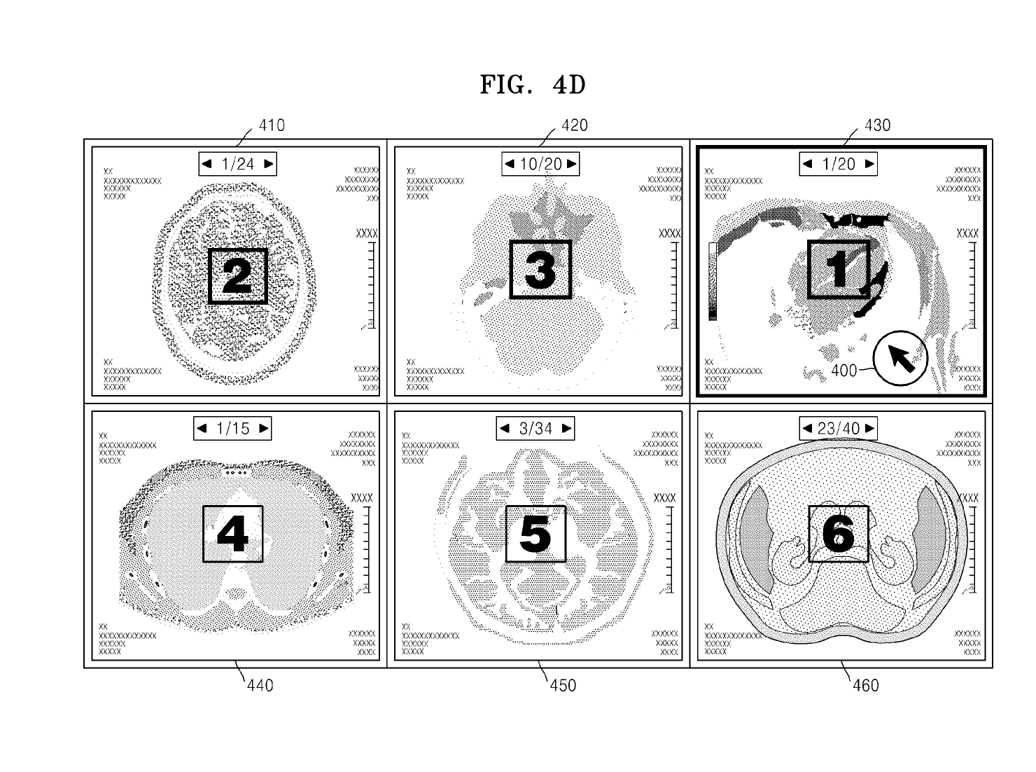

FIGS. 4A, 4B, 4C, and 4D are diagrams which illustrate an example in which an arrangement of a plurality of medical image sets is changed based on a user input which facilitates a movement of a medical image set, displayed in a prior-order region, to a posterior-order region. In FIGS. 4A, 4B, 4C, and 4D, a case in which a user moves a first medical image set to a region in which a third medical image set is displayed will be described as an example.

As illustrated in FIG. 4A, the medical apparatus 100 may display a plurality of medical image sets. For example, the medical apparatus 100 may display a first medical image set in a first region 410, display a second medical image set in a second region 420, display a third medical image set in a third region 430, display a fourth medical image set in a fourth region 440, display a fifth medical image set in a fifth region 450, and display a sixth medical image set in a sixth region 460. In this case, each of the plurality of medical image sets may be displayed as a representative image.

According to an exemplary embodiment, the medical apparatus 100 may display the respective number of medical images included in each of the plurality of medical image sets. For example, when the first medical image set includes twenty cross-sectional images and a representative image of the cross-section images is a first cross-sectional image from among the 20 images, the medical apparatus 100 may indicate, or display, the number of medical images, a number of the representative image, and a medical image search button (for example, ‘ [symbol] 1/20 [symbol] ’) 411 on the representative image of the first medical image set.

According to an exemplary embodiment, the medical apparatus 100 may receive a user input that selects the first medical image set. For example, the medical apparatus 100 may receive an input 400 in which a cursor of a mouse is located on the representative image of the first medical image set and is clicked.

As illustrated in FIG. 4B, the medical apparatus 100 may receive the input 400 in which the first medical image set is clicked for at least a predetermined amount of time. For example, the medical apparatus 400 may receive an input in which the first medical image set is clicked for 5 seconds or more.

In this case, the medical apparatus 100 may switch an operational mode of the first medical image set from a fixed mode to a moving mode. In addition, the medical apparatus 100 may display the first medical image set in semi-transparent blue, in order to indicate a mode shift of the first medical image set to the moving mode.

As illustrated in FIG. 4C, the medical apparatus 100 may receive a drag input that facilitates a movement of the first medical image set, which is displayed in the first region 410, to the third region 430. For example, when the operational mode of the first medical image set is switched to the moving mode, the user may drag the first medical image set into the third region 430 while the first medical image set is being touched, and drop the first medical image set in the third region 430. In this case, the first region 410 may be a higher-order region than that of the third region 430, and the third region 430 may be a lower-order region than that of the first region 430.

As illustrated in FIG. 4D, the medical apparatus 100 may display the first medical image set in the third region 430, based on a drag-and-drop input that facilitates a movement of the first medical image set, which is displayed in the first region 410, to the third region 430. In addition, the medical apparatus 100 may cause the third medical image set, which is displayed in the third region 430, to be moved to the second region 420 to display the third medical image set, and may cause the second medical image set, which is displayed in the second region 420, to be moved to the first region 410 to display the second medical image set. That is, before moving, the first medical image set is displayed in a higher-order region than that of the third medical image set, but after moving, the third medical image set is displayed in a higher-order region than that of the first medical image set.

According to an exemplary embodiment, the medical apparatus 100 may not again load a medical image set in changing the arrangement of a plurality of medical image sets, and a user freely changes the arrangement of the plurality of medical image sets via a simple input.

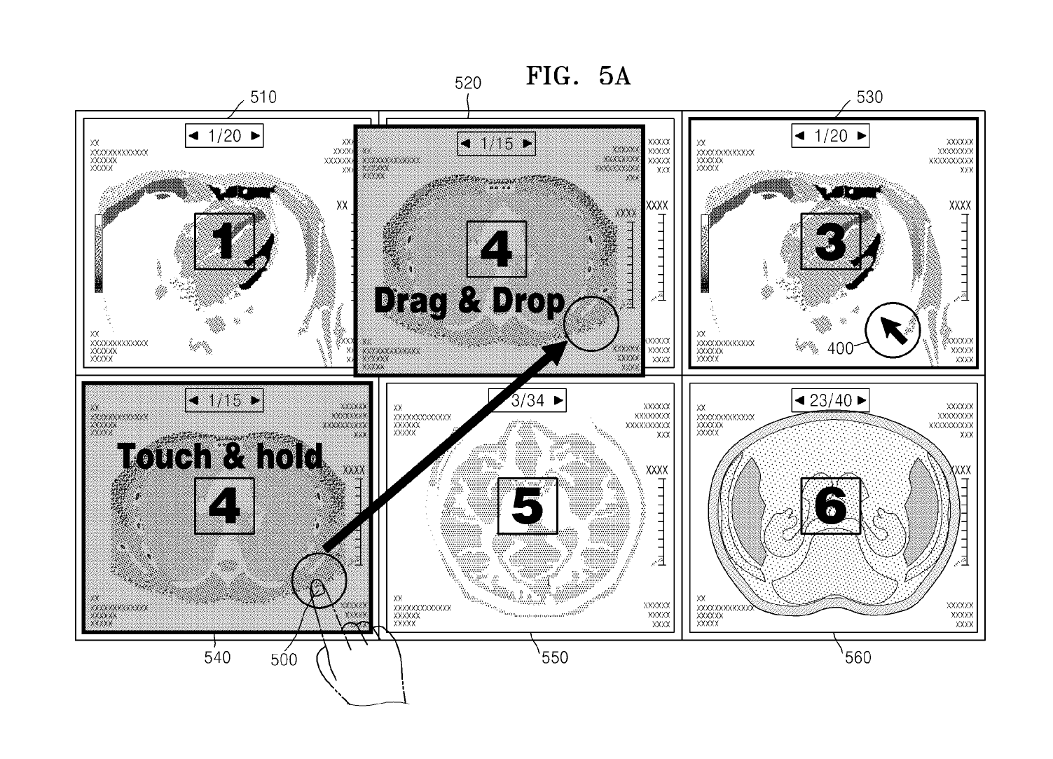

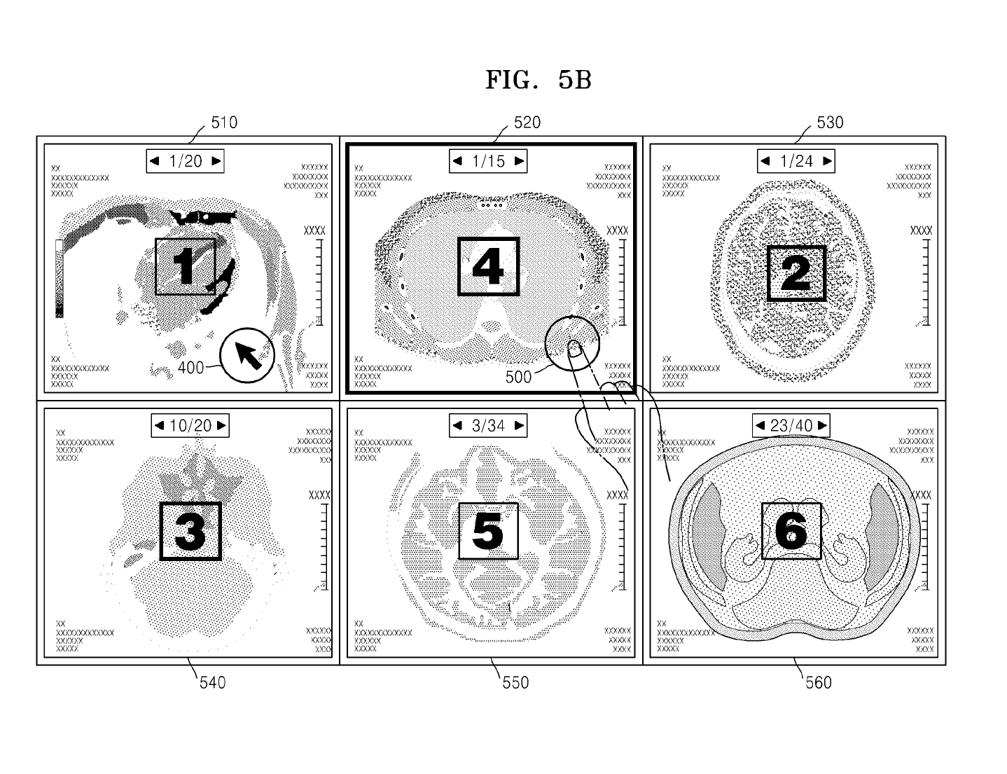

FIGS. 5A and 5B are diagrams which illustrate an example that changes an arrangement of a plurality of medical image sets based on a user input which causes a medical image set, displayed in a posterior-order region, to be moved to a prior-order region. In FIGS. 5A and 5B, a case in which a user moves a fourth medical image set to a region in which a second medical image set is displayed will be described as an example.

As illustrated in FIG. 5A, the medical apparatus 100 may display a plurality of medical image sets. For example, the medical apparatus 100 may display a first medical image set in a first region 510, display a second medical image set in a second region 520, display a third medical image set in a third region 530, display a fourth medical image set in a fourth region 540, display a fifth medical image set in a fifth region 550, and display a sixth medical image set in a sixth region 560.

According to an exemplary embodiment, the medical apparatus 100 may receive a user input that selects the fourth medical image set. For example, the medical apparatus 100 may receive a touch-and-hold input 500 in which the fourth medial image set displayed in the fourth region 540 is touched for at least a predetermined time interval (for example, 5 seconds or more) with a touch tool (for example, a finger or an electronic pen). In this case, the medical apparatus 100 may switch an operational mode of the fourth medical image set from a fixed mode to a moving mode. In addition, the medical apparatus 100 may display the fourth medical image set in semi-transparent green, for indicating the operational mode of the fourth medical image set being switched to the moving mode.

According to an exemplary embodiment, the medical apparatus 100 may receive a drag input that facilitates a movement of the fourth medical image set, which is displayed in the fourth region 540, to the second region 520. For example, when the operational mode of the fourth medical image set is switched to the moving mode, the user may drag the fourth medical image set into the second region 520 while the fourth medical image set is being touched, and drop the fourth medical image set in the second region 520. In this case, the fourth medical image set may be moved from a posterior-order region (for example, the fourth region 540) to a prior-order region (for example, the second region 520).

As illustrated in FIG. 5B, the medical apparatus 100 may display the fourth medical image set in the fourth region 540, based on a drag-and-drop input that facilitates a movement of the fourth medical image set, which is displayed in the fourth region 540, to the second region 520. In addition, the medical apparatus 100 may cause the second medical image set, which is displayed in the second region 520, to be moved into the third region 530 to display the second medical image set, and cause the third medical image set, which is displayed in the third region 530, to be moved into the fourth region 540 to display the third medical image set. In particular, before moving, the second medical image set is displayed in a higher-order region than that of the fourth medical image set, but after moving, the fourth medical image set is displayed in a higher-order region than that of the second medical image set. In this case, the user may compare the second and fourth medical image sets at a time.

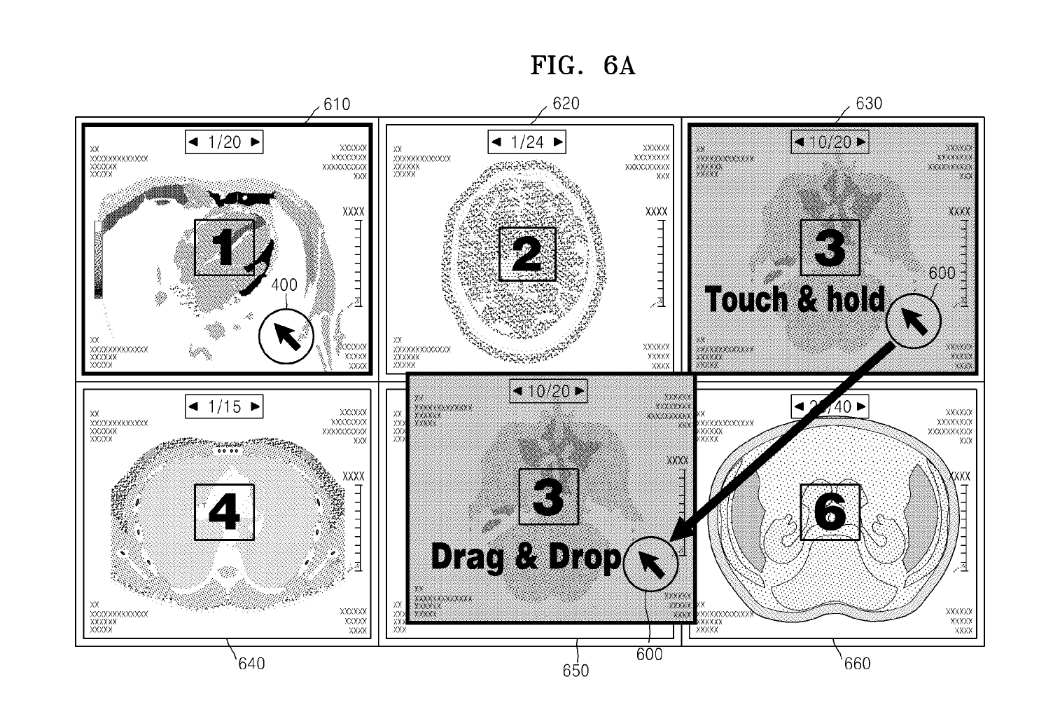

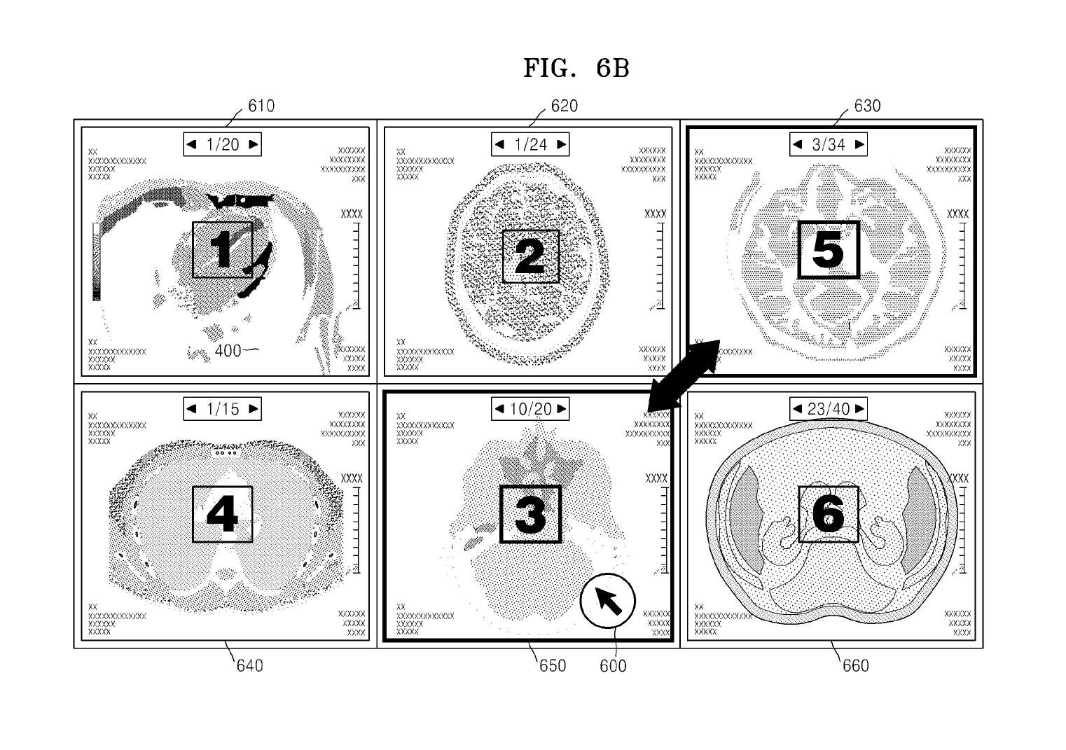

FIGS. 6A and 6B are diagrams which illustrate an example in which positions of a plurality of medical image sets are switched therebetween based on a user input. In FIGS. 6A and 6B, a case in which a user moves a third medical image set to a region in which a fifth medical image set is displayed will be described as an example.

As illustrated in FIG. 6A, the medical apparatus 100 may display a plurality of medical image sets. For example, the medical apparatus 100 may display a first medical image set in a first region 610, display a second medical image set in a second region 620, display a third medical image set in a third region 630, display a fourth medical image set in a fourth region 640, display a fifth medical image set in a fifth region 650, and display a sixth medical image set in a sixth region 660.

According to an exemplary embodiment, the medical apparatus 100 may receive a user input that selects the third medical image set. For example, the medical apparatus 100 may receive a touch-and-hold input 600 in which the third medial image set displayed in the third region 630 is touched for at least a predetermined amount of time (for example, 5 seconds or more) with a touch tool (for example, a finger or an electronic pen). In this case, the medical apparatus 100 may switch an operational mode of the third medical image set from a fixed mode to a moving mode. In addition, the medical apparatus 100 may display the third medical image set in yellow, for indicating a switching of the operational mode of the third medical image set to the moving mode.

According to an exemplary embodiment, the medical apparatus 100 may receive a drag input that facilitates a movement of the third medical image set, which is displayed in the third region 630, to the fifth region 650. For example, when the operational mode of the third medical image set is switched to the moving mode, the user may drag the fourth medical image set into the fifth region 650 while the fourth medical image set is being touched, and drop the third medical image set in the fifth region 650. In this case, the third medical image set may be moved from a prior-order region (for example, the third region 630) to a posterior-order region (for example, the fifth region 650).

As illustrated in FIG. 6B, the medical apparatus 100 may display the third medical image set in the third region 630, based on a drag-and-drop input that facilitates a movement of the third medical image set, which is displayed in the third region 630, to the fifth region 650. In addition, the medical apparatus 100 may cause the fifth medical image set, which is displayed in the fifth region 650, to be moved into the third region 630 to display the second medical image set. In particular, positions of the third and fifth medical image sets may be exchanged therebetween. In this case, the user may compare the third and fourth medical image sets at a time.

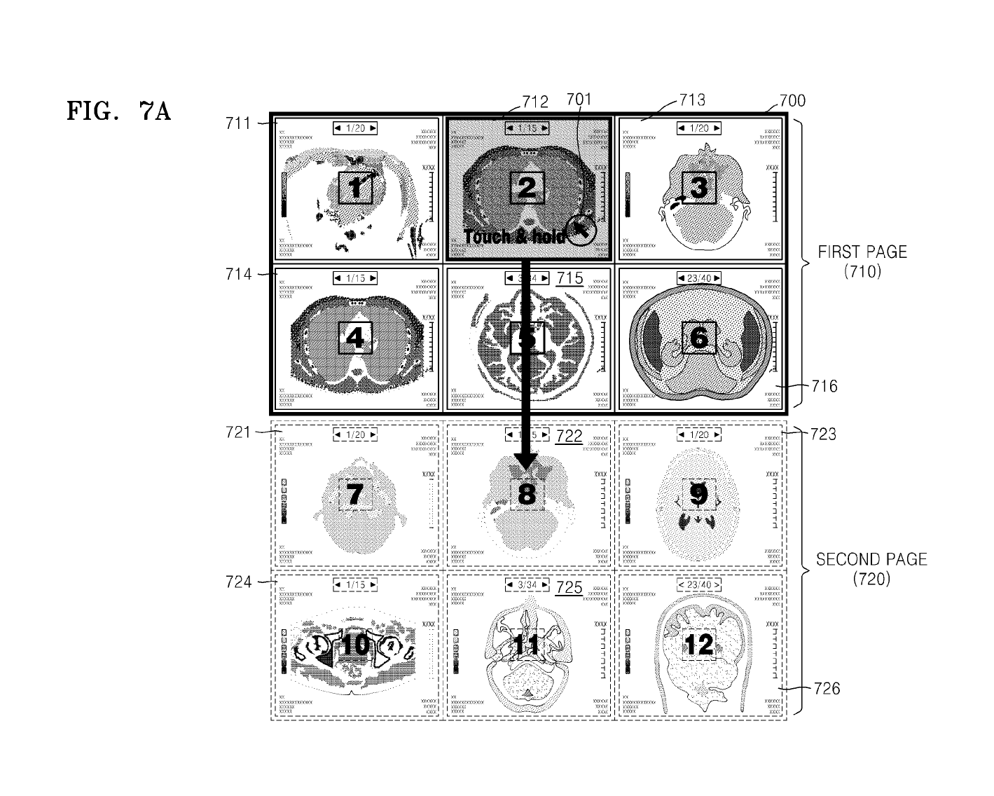

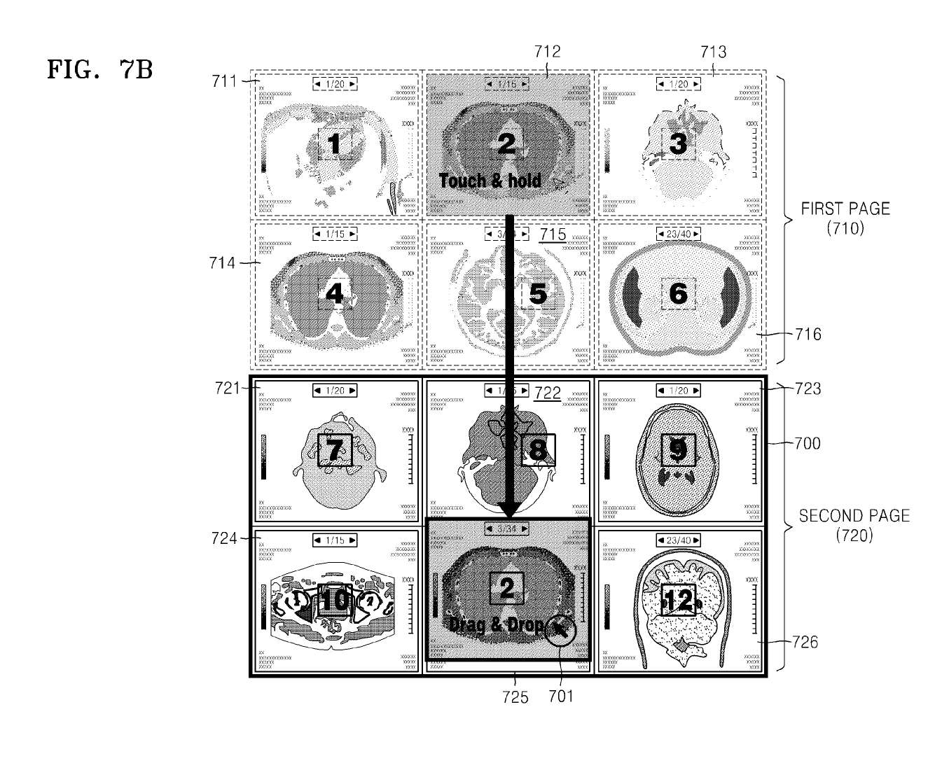

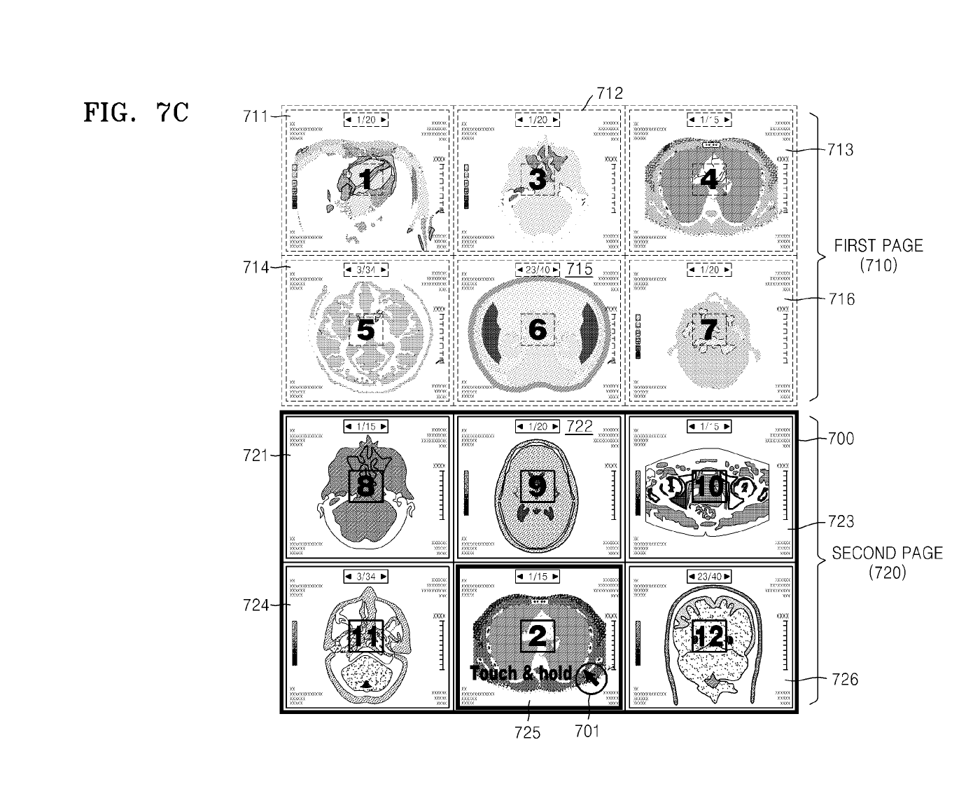

FIGS. 7A, 7B, and 7C are diagrams which illustrate an example that changes the arrangement of a plurality of medical image sets based on an input which causes a movement of a medical image set to another page which is not displayed on a screen.

As illustrated in FIG. 7A, when it is not possible for all of a plurality of medical image sets to be displayed on one screen 700, the medical apparatus 100 may display the medical image sets in a plurality of pages. For example, the medical apparatus 100 may display a first medical image set in a first region 711 of a first page 710, display a second medical image set in a second region 712 of the first page, display a third medical image set in a third region 713 of the first page, display a fourth medical image set in a fourth region 714 of the first page, display a fifth medical image set in a fifth region 715 of the first page, and display a sixth medical image set in a sixth region 716 of the first page. In addition, the medical apparatus 100 may display a seventh medical image set in a first region 721 of a second page 720, display an eighth medical image set in a second region 722 of the second page, display a ninth medical image set in a third region 733 of the second page, display a tenth medical image set in a fourth region 744 of the second page, display an eleventh medical image set in a fifth region 725 of the second page, and display a twelfth medical image set in a sixth region 726 of the second page.

According to an exemplary embodiment, the medical apparatus 100 may receive a user input that selects a second medical image set included in the first page 710 which is being displayed on the screen 700. For example, the medical apparatus 100 may receive a touch-and-hold input 701 in which the second medical image set displayed in the second region 712 of the first page 710 is touched for at least a predetermined amount of time (for example, 5 seconds or more). In this case, the medical apparatus 100 may switch an operational mode of the second medical image set from a fixed mode to a moving mode. In addition, the medical apparatus 100 may display the second medical image set in semi-transparent blue, for indicating a switching of the operational mode of the second medical image set to the moving mode.

As illustrated in FIG. 7B, the medical apparatus 100 may receive a drag input that facilitates a movement of the second medical image set, which is displayed in the second region 712 of the first page 710 to the fifth region 725 of the second page 720. For example, when the operational mode of the second medical image set is switched to the moving mode, the user may drag the second medical image set in a lower-end direction of the screen while the second medical image set is being touched to prompt the medical apparatus 100 to display the second page 720, and then drop the second medical image set in the fifth region 725 of the second page 720. In this case, the second medical image set which was located in the first page 710 may be moved to the second page 720.

As illustrated in FIG. 7C, the medical apparatus 100 may display the second medical image set in the fifth region 725 of the second page 720, based on a drag-and-drop input that facilitates a movement of the second medical image set, which is displayed in the second region 712 of the first page 710, to the fifth region 725 of the second page 720.

In addition, the medical apparatus 100 may cause the third medical image set displayed in the third region 713 of the first page 710 to be moved to the second region 712 of the first page 710, cause the fourth medical image set displayed in the fourth region 714 of the first page 710 to be moved to the third region 713 of the first page 710, cause the fifth medical image set displayed in the fifth region 715 of the first page 710 to be moved to the fourth region 714 of the first page 710, cause the sixth medical image set displayed in the sixth region 716 of the first page 710 to be moved to the fifth region 715 of the first page 710, cause the seventh medical image set displayed in the first region 721 of the second page 720 to be moved to the sixth region 716 of the first page 710, cause the eighth medical image set displayed in the second region 722 of the second page 720 to be moved to the first region 721 of the second page 720, cause the ninth medical image set displayed in the third region 723 of the second page 720 to be moved to the second region 722 of the second page 720, cause the tenth medical image set displayed in the fourth region 724 of the second page 720 to be moved to the third region 723 of the second page 720, and cause the eleventh medical image set displayed in the fifth region 725 of the second page 720 to be moved to the fourth region 724 of the second page 720. In this case, the user may compare the second and twelfth medical image sets at a time together with the third medical image.

In FIGS. 7A, 7B, and 7C, the case in which the plurality of pages is arranged in a vertical direction has been described as an example, but the present exemplary embodiment is not limited thereto. For example, the plurality of pages may be arranged in a horizontal direction or a diagonal direction.

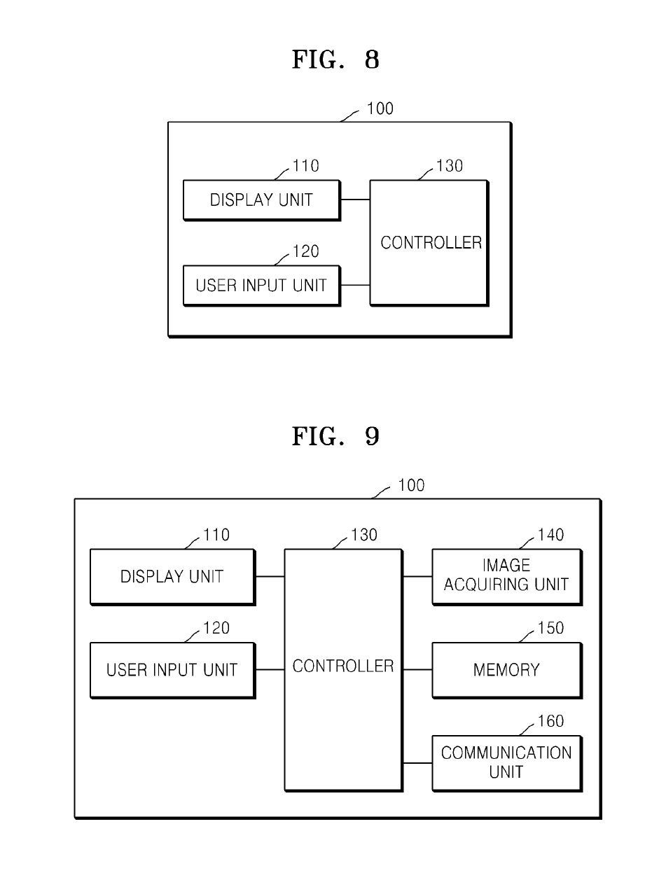

FIGS. 8 and 9 are block diagrams which illustrate a medical apparatus, according to an exemplary embodiment.

As illustrated in FIGS. 8 and 9, the medical apparatus 100 according to an exemplary embodiment may include a display unit (also referred to herein as a “display device”) 110, a user input unit (also referred to herein as a “user input device”) 120, and a controller 130. However, the elements are not all essential elements. The medical apparatus may be configured with more elements than the illustrated elements, or may be configured with fewer elements than those illustrated. For example, as illustrated in FIG. 9, the medical apparatus 100 according to an exemplary embodiment may further include an image acquiring unit (also referred to herein as an “image acquirer” and/or as an “image acquisition device”) 140, a memory 150, and a communication unit (also referred to herein as a “communicator” and/or as a “transceiver” and/or as a “transmitter/receiver”) 160, in addition to the display unit 110, the user input unit 120, and the controller 130.

Hereinafter, the elements will be sequentially described.

The display unit 110 displays and outputs information obtained via processing by the medical apparatus 100. For example, the display unit 110 may display a medical image, or display a user interface (UI) or a GUI relating to a control panel.

The display unit 110 may display a plurality of medical image sets. For example, the display unit 110 may display a plurality of medical image sets which includes first and second medical image sets. In this case, either or both of the first medical image set and the second medical image set may include a plurality of cross-sectional images of an object.

According to an exemplary embodiment, the first medical image set may include a plurality of medical images that are acquired by using a first protocol, and the second medical image set may include a plurality of medical images that are acquired by using a second protocol which is different from the first protocol.

The display unit 110 may display a list of representative images which correspond to respective ones of the plurality of medical image sets. The display unit 110 may display a respective number of medical images included in each corresponding one of the plurality of medical image sets.

When an operational mode of the first medical image set is switched from the fixed mode to the moving mode, the display unit 110 may display an indicator which indicates the moving mode on the first medical image set.

When the display unit 110 is configured with a touch screen in which a touch pad forms a layer structure, the display unit 110 may be used as an input device, in addition to functioning as an output device. The display unit 110 may include at least one of a liquid crystal display (LCD), a thin film transistor-liquid crystal display (TFT-LCD), an organic light-emitting diode (OLED) display, a flexible display, a 3D display, and an electrophoretic display. The medical apparatus 100 may include two or more the display units 110, depending on an implementation type of the medical apparatus 100.

The user input unit 120 may denote a device that enables a user (for example, a sonographer) to input data used to control the ultrasound apparatus 1000. For example, the user input unit 120 may include any one or more of a keypad, a dome switch, a touch pad (for example, of a contact capacitive type, a press resistive type, an infrared sensing type, a surface ultrasound conductive type, an integration tension measurement type, or a piezo effect type), a jog wheel, and a jog switch, but is not limited thereto. For example, the user input unit 120 may further include any one or more of various other input devices, including an electrocardiogram measuring module, a respiration measuring module, a voice recognition sensor, a gesture recognition sensor, a fingerprint recognition sensor, an iris recognition sensor, a depth sensor, a distance sensor, and/or any other suitable type of input device.

The user input unit 120 may receive a selection of the first medical image set from among the plurality of medical image sets. For example, the user input unit 120 may receive a touch input in which the first medical image set is touched for at least a predetermined amount of time.

The user input unit 120 may receive a user input that facilitates a movement of the first medical image set to a region in which the second medical image set is displayed. For example, the user input unit 120 may receive a drag input that causes the first medical image set to be dragged into the region, in which the second medical image set is displayed, while the first medical image set is being touched.

The controller 130 controls an overall operation of the medical apparatus 100. For example, the controller 130 may globally control the display unit 110, the user input unit 120, the image acquiring unit 140, the memory 150, and the communication unit 160.

The controller 130 may change an arrangement of the plurality of medical image sets based on a user input. For example, based on the user input, the controller 130 may cause the first medical image set to be moved to a first region in which the second medical image set is displayed, and cause the second medical image set to be moved to a region which is previous or subsequent to (I.e., different from) the first region.

Moreover, the controller 130 may cause the first medical image set to be moved to the first region in which the second medical image set is displayed, and cause the second medical image set to be moved to a second region in which the first medical image set was displayed.

The controller 130 may select the representative images which respectively correspond to the plurality of medical image sets, and may control the display unit 110 to display a list of the selected representative images.

The controller 130 may switch the operational mode of the first medical image set to the moving mode in order for the first medical image set to be moved based on the user's drag input, based on a touch input in which the first medical image set is touched for at least a predetermined amount of time. Further, the controller 130 may change a color associated with the first medical image set to a color which corresponds to the moving mode.

The image acquiring unit 140 may acquire a medical image of an object. For example, the image acquiring unit 140 may transmit an ultrasound signal from a surface to a certain part of the object, and obtain a tomography image of a soft tissue or an image of blood flow by using information which relates to an ultrasound signal reflected from an internal tissue of the human body.

Moreover, the image acquiring unit 140 may express an intensity of a magnetic resonance (MR) signal to an RF signal (which is generated in a magnetic field having a certain intensity) as a contrast, and thus obtain a tomographic image of a part of an object. The image acquiring unit 140 may irradiate X-rays onto an object in order to acquire a CT image or an X-ray image.

The memory 150 may store a program for execution by the controller 130, and store input/output data (for example, any one or more of ultrasound image data, elasticity data, information which relates to a region of interest (ROI), an ultrasound image, examinee information, probe information, a body marker, additional information, etc.).

The memory 150 may include at least one type of storage medium, such as, for example, any one or more of a flash memory, a hard disk, a multimedia micro card, a card type memory (a secure digital (SD) card, an extreme digital (XD) card, or the like), a random access memory (RAM), a static random access memory (SRAM), a read-only memory (ROM), an electrically erasable programmable read-only memory (EEPROM), and a programmable read-only memory (PROM). Further, the medical apparatus 100 may use web storage and/or a cloud server which performs a storage function of the memory 150 on the World Wide Web and/or the Internet.

The communication unit 160 may include one or more elements that enable communication between the medical apparatus 100 and a server and/or between the medical apparatus 100 and an external device. For example, the communication unit 160 may include any one or more of a short-distance communication module, a wired communication module, and a mobile communication module.

The short-distance communication module may refer to a module for close-distance communication within a predetermined threshold distance. Examples of close-distance communication techniques, according to an exemplary embodiment, may include any one or more of wireless local area network (WLAN), Wi-Fi, Bluetooth, Zigbee, Wi-Fi Direct (WFD), ultra wideband (UWB), infrared data association (IrDA), Bluetooth Low Energy (BLE), and near field communication (NFC). However, the exemplary embodiments are not limited thereto.

The wired communication module refers to a module for communication using electric signals or optical signals. Examples of wired communication techniques, according to an exemplary embodiment, may include any one or more of a pair cable, a coaxial cable, an optical fiber cable, and an Ethernet cable.

The mobile communication module transmits to and receives wireless signals from at least one of a base station, an external device, and the server over a mobile communication network. In particular, the wireless signals may include any one or more of voice call signals, video call signals, and/or various types of data for transmission and reception of text/multimedia messages.

The communication unit 160 is wiredly or wirelessly connected to a network and communicates with an external device and/or a server. The communication unit 160 may exchange data with a hospital server and/or another medical device in a hospital that is connected with a picture archiving and communications system (PACS). Furthermore, the communication unit 160 may perform data communication in accordance with the digital imaging and communications in medicine (DICOM) standard.

The communication unit 160 may transmit and receive data which relates to a diagnosis of an object, e.g., an ultrasound image, ultrasound data, and Doppler data of the object, via the network, and may also transmit and receive medical images obtained via other medical devices. Furthermore, the communication unit 160 may receive information which relates to a diagnosis history or treatment schedule of a patient from a server and utilize the information for diagnosing the patient.

As described above, according to the one or more of the above-described exemplary embodiments, the medical apparatus 100 enables a user to freely change an arrangement of a plurality of medical image sets via simple manipulation.

One or more of the above exemplary embodiments may be implemented as computer readable codes in a transitory or non-transitory computer readable medium. The computer readable recording medium may include a program instruction, a local data file, a local data structure, and/or a combination thereof. The computer readable recording medium may be specific to exemplary embodiments or commonly known to those of ordinary skill in computer software. The computer readable recording medium includes any one or all types of recordable media in which computer readable data are stored. Examples of the computer readable recording medium include a magnetic medium, such as a hard disk, a floppy disk and a magnetic tape, an optical medium, such as a CD-ROM and a DVD, a magneto-optical medium, such as a floptical disk, and a hardware memory, such as a ROM, a RAM and a flash memory, specifically configured to store and execute program instructions. Furthermore, the computer readable recording medium may be implemented in the form of a transmission medium, such as light, wire or waveguide, to transmit signals which designate program instructions, local data structures and the like. Examples of the program instruction include machine code, which is generated by a compiler, and a high level language, which is executed by a computer using an interpreter and so on.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present inventive concept as defined by the following claims.

What is claimed is:

1. A method for arranging a plurality of medical images, the method comprising:
displaying a plurality of medical image sets;
receiving a selection of a first medical image set from among the plurality of medical image sets;
receiving a user input that facilitates a movement of the selected first medical image set to a region in which a second medical image set is displayed; and
changing an arrangement of the plurality of medical image sets, based on the received user input.

2. The method of claim 1, wherein the first medical image set comprises a plurality of cross-sectional images of an object.

3. The method of claim 1, wherein
the first medical image set comprises a first plurality of medical images that are acquired by using a first protocol, and
the second medical image set comprises a second plurality of medical images that are acquired by using a second protocol that is different from the first protocol.

4. The method of claim 1, wherein the displaying the plurality of medical image sets comprises:
for each of the plurality of medical image sets, selecting at least one respective representative image; and
displaying a list of the selected representative images.

5. The method of claim 1, wherein the displaying the plurality of medical image sets comprises displaying, for each of the plurality of medical image sets, information which relates to a respective number of medical images included in the corresponding one of the plurality of medical image sets.

6. The method of claim 1, wherein the receiving the selection comprises:
receiving a drag input by which the first medical image set is touched for at least a predetermined time interval; and
switching an operational mode of the first medical image set to a moving mode such that the first medical image set is moved based on the drag input.

7. The method of claim 6, wherein the switching the operational mode comprises changing a color associated with the first medical image set to a color which corresponds to the moving mode.

8. The method of claim 6, wherein the switching the operational mode comprises providing an indicator which indicates the moving mode on the first medical image set.

9. The method of claim 1, wherein the receiving the user input comprises receiving a drag input by which the first medical image set is dragged into the region in which the second medical image set is displayed, while the first medical image set is being touched.

10. The method of claim 1, wherein the changing the arrangement comprises:
causing the first medical image set to be moved into a first region in which the second medical image set is displayed; and
causing the second medical image set to be moved into a region which is different from the first region.

11. The method of claim 1, wherein the changing the arrangement comprises causing the first medical image set to be moved into a first region in which the second medical image set is displayed, and causing the second medical image set to be moved into a second region in which the first medical image set was displayed prior to being moved into the first region.

12. A medical apparatus comprising:
a display device configured to display a plurality of medical image sets;
a user input device configured to receive a selection of a first medical image set from among the plurality of medical image sets, and to receive a user input that facilitates a movement of the selected first medical image set to a region in which a second medical image set is displayed; and
a controller configured to change an arrangement of the plurality of medical image sets, based on the received user input.

13. The medical apparatus of claim 12, wherein the first medical image set comprises a plurality of cross-sectional images of an object.

14. The medical apparatus of claim 12, wherein,
the first medical image set comprises a first plurality of medical images that are acquired by using a first protocol, and
the second medical image set comprises a second plurality of medical images that are acquired by using a second protocol that is different from the first protocol.

15. The medical apparatus of claim 12, wherein the controller is further configured to select, for each of the plurality of medical image sets, at least one representative image, and to control the display device to display a list of the selected representative images.

16. The medical apparatus of claim 12, wherein the display device is further configured to display, for each of the plurality of medical image sets, information which relates to a respective number of medical images included in the corresponding one of the plurality of medical image sets.

17. The medical apparatus of claim 12, wherein,
the user input device is further configured to receive a drag input by which the first medical image set is touched for at least a predetermined time interval, and
the controller is further configured to switch an operational mode of the first medical image set to a moving mode such that the first medical image set is moved, based on the drag input.

18. The medical apparatus of claim 17, wherein the controller is further configured to change a color associated with the first medical image set to a color which corresponds to the moving mode.

19. The medical apparatus of claim 17, wherein the display device is further configured to display an indicator which indicates the moving mode on the first medical image set.

20. The medical apparatus of claim 12, wherein the user input device is further configured to receive a drag input by which the first medical image set is dragged into the region in which the second medical image set is displayed, while the first medical image set is being touched.

21. The medical apparatus of claim 12, wherein the controller is further configured to cause the first medical image set to be moved into a first region in which the second medical image set is displayed, and to cause the second medical image set to be moved into a region which is different from the first region.

22. The medical apparatus of claim 12, wherein the controller is further configured to cause the first medical image set to be moved into a first region in which the second medical image set is displayed, and to cause the second medical image set to be moved into a second region in which the first medical image set was displayed prior to being moved into the first region.

23. A non-transitory computer-readable storage medium storing a program for executing the method of claim 1.
